(19) United States
(12) Patent Application Publication
(10) Pub. No.: US 2009/0134771 A1
(43) Pub. Date: May 28, 2009

(54) ARC TUBE AND METHOD OF PHOSPHOR COATING

(76) Inventors: Kenji Itaya, Osaka (JP); Toyokazu Amano, Kyoto (JP); Junichi Takahashi, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/064,291

(22) PCT Filed: Nov. 1, 2006
(86) PCT No.: PCT/JP2006/321911

§ 371 Date: Feb. 20, 2008

(30) Foreign Application Priority Data
Nov. 7, 2005 (JP) 2005-322492

(51) Int. Cl. H01J 1/62; B05D 5/06

(52) U.S. Cl. 313/493; 427/66

(57) ABSTRACT

A method of uniformly applying a phosphor onto the internal surface of a glass tube of spiral configuration having opening at its both ends. After an injection process is performed while glass tube (11) is held with openings (24,25) facing upward, the glass tube is turned upside down and held such that the openings are positioned in the inferior region. While rotating the glass tube around pivot axis (A), the phosphor suspension is caused to flow out. The glass tube is turned upside down once more and held to cause the openings to position in the superior region for a given period of time with the result that the phosphor suspension is caused to flow to uniformize the thickness thereof. Further once more the glass tube is turned upside down to cause the openings to position in the inferior region. In that state, a preliminary drying process is performed.

### TECHNICAL FIELD

The present invention relates to an arc tube and a phosphor coating method.

### BACKGROUND ART

A fluorescent lamp includes a phosphor coating being formed on the inner surface of the glass tube. This phosphor coating is formed by applying a phosphor suspension to the inner surface and then sintering it.

Now, in this age of energy conservation, various phosphor lamps are developed in place of common incandescent lamps. In recent years, particularly, an adoption of spiral-shaped arc tubes including spiral-shaped glass tubes, which are advantageous in terms of downsizing, has been studied.

A double spiral glass tube (refer to Patent Document 1) has a turning part in the center thereof, and is wound from the turning part towards both ends around the spiral axis. Therefore, a discharge path of the double spiral glass tube can be lengthened while the size of that remaining compact, with it being possible to increase the amount of light emission.

A phosphor coating method for such a double spiral glass tube includes, for example, the following processes: (a) injecting a phosphor suspension into the glass tube through one of openings thereof and coating the inner surface, (b) retaining the glass tube in a position such that the openings face downward in order for the phosphor suspension to flow and drain out of the openings, and (c) drying the glass tube to form a phosphor coating.

It is preferable that the amount of the phosphor suspension that coats the inner surface of the glass tube be even. When the amount of coating is uneven, that is, when the phosphor coating is not formed evenly to a predetermined thickness, ultraviolet light generated within the glass tube may not be converted to visible light at a sufficient efficiency at a portion with a thin phosphor coating (insufficient amount of coating). And, on the other hand, at a portion with a thick phosphor coating (excessive amount of coating), light may be prevented from being emitted out of the glass tube by the formed phosphor coating. These cause inconsistency in light as a result.

### Patent Document 1: Japanese Patent Publication No. 2004-186147

### Patent Document 2: Japanese Patent Publication No. 2005-158467

### Patent Document 3: Japanese Patent Publication No. 2003-173760

### Patent Document 4: Japanese Patent Publication No. 2004-79362

### Patent Document 5: Specification of German Patent No. 860675

### Patent Document 6: Specification of German Patent No. 871927

### DISCLOSURE OF THE INVENTION

### Problems the Invention is Going to Solve

However, study conducted by the present inventors has revealed that the amount of phosphor suspension that coats the inner surface of the double spiral glass tube manufactured using the above processes (a) to (c) becomes uneven in the following two patterns.

(1) Unevenness throughout the glass tube, that is, the closer to the turning part, the less the amount of the coating becomes, and the further from the turning part (closer to the openings), the more the amount of the coating becomes.

(2) Unevenness in cross sections of spiral parts, that is, the amount of coating on the cross sections of the winding spiral parts is less at the turning part side and more at the opposite side, which is the openings side.

Such unevenness in the amount of coating is not a problem unique to the double spiral glass tube but common to a glass tube with a winding shape such as a single spiral.

The present invention was conceived to solve the above problem, and aims to provide an arc tube having a phosphor coating with a thickness being more consistent than that of conventional arc tubes.

Also, the present invention aims to provide a phosphor coating method for coating the inner surface of a spiral shape glass tube, by which unevenness in a coated amount of a phosphor suspension can be suppressed.

### Means of Solving the Problems

In order to achieve the above-mentioned aim, an arc tube of claim 1 in accordance with the present invention is an arc tube comprising a vertical double-spiral glass tube which includes a phosphor coating disposed on an inner surface thereof, and the glass tube includes a spiral part made up of (i) a first spiral part wound around a spiral axis from a turning part to one end of the glass tube, and (ii) a second spiral part wound around the spiral axis from the turning part to another end of the glass tube, the turning part being positioned at a substantially central location in a tube longitudinal direction of the glass tube, in a transverse cross section at a point along a discharge path of one of the first spiral part and second spiral part, a thickness of the phosphor coating at an area (wu) that is nearer, compared to an opposing area thereof, to the turning part and a thickness of the phosphor coating at the opposing area (wd) satisfy a relationship of ½≦wd/wu≦2.

Also, an arc tube of claim 2 in accordance of the present invention is an arc tube comprising a flat double-spiral glass tube in which a tube axis substantially lies in a single plane, the glass tube being in a flat shape deformed from an externally substantially cone-shaped glass tube, and a phosphor coating is disposed on an inner surface of the glass tube, the glass tube includes a winding part made up of (i) a first winding part wound into a flat spiral from a turning part to one end of the glass tube, and (ii) a second winding part wound into a flat spiral from the turning part to another end of the glass tube, the turning part being positioned at a substantially central location in a tube longitudinal direction of the glass tube, and in a transverse cross section at a point along a discharge path of one of the first spiral part and second spiral part, a thickness of the phosphor coating at one (wd) of two areas and a thickness of the phosphor coating at the other area (wu) satisfy ½≦wd/wu≦2, the two areas being located in a direction orthogonal to the plane and facing each other across the plane.

Also, an arc tube of claim 3 in accordance with the present invention is an arc tube comprising a vertical single-spiral glass tube which includes a phosphor coating disposed on an inner surface thereof, and the glass tube includes a spiral part wound around a spiral axis, and in a transverse cross section at a point along a discharge path of one of the first spiral part and second spiral part, a thickness of the phosphor coating at one (wd) of two areas and a thickness of the phosphor coating at the other area (wu) satisfy ½≦wd/wu≦2, the two areas facing each other in a direction that is parallel to the spiral axis and passes through a center of the cross section.

A phosphor coating method of claim 4 in accordance with the present invention is a phosphor coating method for coating an inner surface of a spiral-shaped glass tube including a winding spiral part and two openings, each disposed at different one of two ends of the glass tube, the phosphor coating method comprising: (a) an injection step of injecting a phosphor suspension into the glass tube; (b) a draining step of draining the phosphor suspension from at least one of the openings after the injection step while the glass tube is retained such that the at least one of the openings is positioned, within the glass tube, on a lower side in a vertical direction; (c) a reverse step of flowing a remainder of the phosphor suspension in the glass tube in a direction opposite to the at least one of the openings after the draining step while the glass tube is retained such that the at least one of the openings is positioned, within the glass tube, on an upper side in the vertical direction; and (d) a drying step of drying the remainder of the phosphor suspension in the glass tube after the reverse step while the glass tube is retained such that the at least one of the openings is positioned on the lower side.

A phosphor coating method of claim 5 in accordance with the present invention is the phosphor coating method of claim 4, and the glass tube is in a double spiral shape such that (i) when one of the openings is positioned on the upper side, the other opening is also positioned on the upper side, and (ii) when one of the openings is positioned on the lower side, the other opening is also positioned on the lower side.

A phosphor coating method of claim 6 in accordance with the present invention is the phosphor coating method of claim 4, and the glass tube is in a single spiral such that (i) when one of the openings is positioned on the upper side, the other opening is positioned on the lower side, and (ii) when one of the openings is positioned on the lower side, the other opening is positioned on the upper side. Here, in the draining step, the phosphor suspension is drained from one of the openings while the glass tube is retained such that the one of the openings is positioned on the lower side and the other opening is positioned on the upper side, in the reverse step, a remainder of the phosphor suspension in the glass tube is flowed in the direction opposite to the one of the openings while the glass tube is again retained such that the one of the openings is positioned on the upper side and the other opening is positioned on the lower side, and in the drying step, the remainder of the phosphor suspension in the glass tube is dried while the glass tube is again retained such that the one of the openings is positioned on the lower side and the other opening is positioned on the upper side.

### Effects of the Invention

Conventionally, a cross section of spiral parts or winding parts has areas which show particularly large differences in thickness of the phosphor coating. However, according the arc tube of the present invention, these differences are suppressed so that even in such a cross section, a thickness in any one area is no more than twice that in another area. Consequently, the thickness of each part is kept within an optimal range, achieving a better luminous efficiency than when using the conventional techniques.

Also, according to the phosphor coating method of the present invention, a phosphor suspension which has flowed unevenly towards one of the openings side of the glass tube in the draining process is flowed back in an opposite direction of the one of the openings side in the following reverse process, thereby the unevenness of the coated amount of the phosphor suspension can be corrected.

### BRIEF DESCRIPTION OF THE DRAWINGS

FIG. 1 is a partially cut-away front view showing a double spiral fluorescent lamp 1;

FIG. 2 is a partially cut-away front view showing an arc tube 2 of the double spiral fluorescent lamp 1;

FIG. 3 shows an overall flow of a phosphor coating process;

FIG. 4 is an enlarged front view of C part of a glass tube 11 in FIG. 3D;

FIG. 5 is an enlarged front view of B part of the glass tube 11 in FIG. 2;

FIG. 6 is a table showing measurement results of amounts of coating;

FIG. 7 is a diagram drawn based on the table in FIG. 6;

FIG. 8A is a graph comparing initial luminous fluxes, FIG. 8B is a graph comparing luminous flux maintenance;

FIG. 9A is a partially cut-away exploded plan view of a flat double-spiral fluorescent lamp 31, FIG. 9B is a front view of the flat double-spiral fluorescent lamp 31;

FIG. 10 is a schematic-diagram showing an outline of an arc tube manufacturing process;

FIG. 11 shows an overall flow of a phosphor coating process;

FIG. 12 is a table showing measurement results of amounts of coating;

FIG. 13 is a diagram drawn based on the table in FIG. 12; and

FIG. 14A is a graph comparing initial luminous fluxes, FIG. 14B is a graph comparing luminous flux maintenance.

### DESCRIPTION OF REFERENCE NUMERALS

1 double spiral fluorescent lamp

2, 32 arc tube

7, 38, 52 turning part

11, 33 glass tube

12, 13 end part

16, 53 spiral part

16a first spiral part

16b second spiral part

24, 25, 54, 55 opening

26, 57 phosphor suspension

31 flat double-spiral fluorescent lamp

39 winding part

39a first winding part

39b second winding part

51 glass tube (double spiral)

### BEST MODE FOR CARRYING OUT THE INVENTION

The following describes embodiments of the present invention with reference to drawings.

### First Embodiment

1. Structures of Double Spiral Fluorescent Lamp and Arc Tube

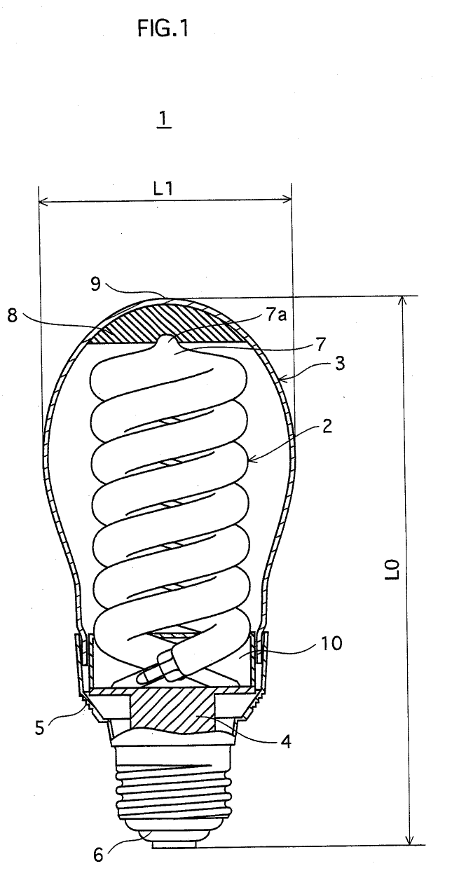

FIG. 1 is a partially cut-away front view showing a double spiral fluorescent lamp 1 (hereinafter, referred to as “present invention A”) which is a first embodiment of the present invention.

As shown in FIG. 1, the double spiral fluorescent lamp 1 includes a double spiral arc tube 2, an outer tube bulb 3 covering the arc tube 2, an electronic ballast 4, a case 5 housing the electronic ballast 4, and an E-type base 6. The double spiral fluorescent lamp 1 is a 22 W compact self-ballasted fluorescent lamp, and is an alternative to a 100 W incandescent lamp.

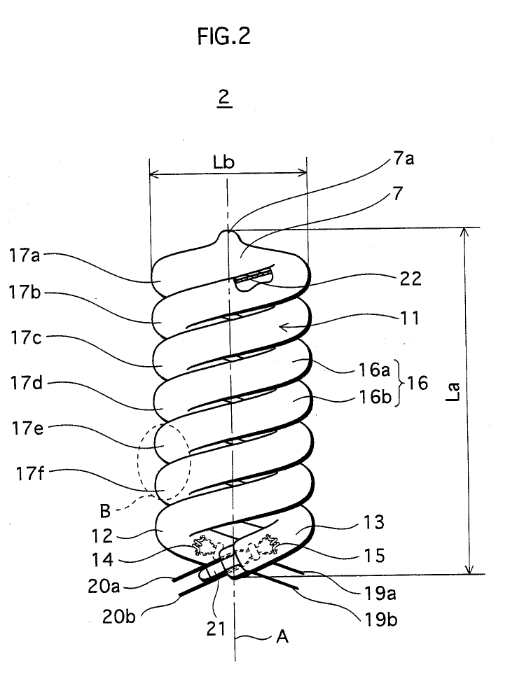

The arc tube 2 has a double spiral part, that is, a vertically long winding part being shaped like a soft-serve ice cream and being wound with a constant diameter. A protrusion 7a is formed at a turning part (head part) 7 at the top of the double spiral arc tube 2, and end parts 12 and 13, to which a pair of electrodes 14 and 15 (refer to FIG. 2) are sealed in are held by and attached to a holding substrate 10 made of resin.

The protrusion 7a is connected to a head part 9 of the outer tube bulb 3 via a thermally-conductive medium 8 made of transparent silicon resin. Thus, when the arc tube 2 emits light, the protrusion 7a which radiates heat efficiently becomes the coldest spot therein. A temperature of the above-mentioned coldest spot is set to be in a range of 55° C. to 65° C. at which a luminous efficiency of the lamp is high.

The inner surface of the outer tube bulb 3 is coated with a white diffusion layer mainly composed of calcium carbonate powder.

The electronic ballast 4 employs a series-inverter method and has a circuit efficiency of 91%.

FIG. 2 is a partially cut-away front view showing the arc tube 2 of the double spiral fluorescent lamp 1 of the present embodiment, and part of a glass tube 11 is cut away to provide a view of a cross section thereof.

The arc tube 2 includes the glass tube 11 that provides a discharge path, and the pair of electrodes 14 and 15 that have the discharge path there between, disposed in the end parts 12 and 13 of this glass tube.

The glass tube 11 includes a double-spiral shaped spiral part 16. The spiral part 16 includes a first spiral part 16a and a second spiral part 16b. The first spiral part 16a is wound, starting from the turning part 7, around a spiral axis A up to one end part 12. The second spiral part 16b is wound, starting from the turning part 7, around the spiral axis A up to the other end part 13.

Both spiral parts 16a and 16b are wound approximately 6.5 times.

Here, as shown in FIG. 2, reference numerals 17a to 17f are assigned to the spiral part 16 of the glass tube 11, from the turning part 7 at the top side toward the end parts 12 and 13 at the bottom side in a sequential manner.

The electrodes 14 and 15 are supported by a pair of lead wires 19a and 19b/20a and 20b, respectively.

The leadwires 19a, 19b, 20a and 20b are sealed in airtight by pinch-sealing at the end parts 12 and 13 of the glass tube using a so-called glass bead mounting method. Accordingly, the glass tube 11 has a pinch-sealing part at each end part 12/13 of the glass tube 11. Also, an exhaust pipe 21 (its top part is sealed after evacuating the arc tube) is sealed to one end part 13 of the glass tube.

The glass tube 11 is made of barium strontium silicate glass (softening temperature is 675.2° C.), a soft glass, and encloses therein approximately 5 mg of mercury as light-emitting material and an argon gas at a pressure of approximately 500 Pa at an ordinary temperature as a buffer rare gas.

On the inner surface of the glass tube 11, a phosphor coating 22 is formed. The phosphor coating 22 includes a phosphor which converts ultraviolet light to visible light. A mixture of phosphors emitting each color of red (Y₂O₃:Eu³⁺), green (LaPO₄:Ce³⁺,Tb³⁺) and blue (BaMg₂Al₁₆O₂₇:Eu²⁺) are used as the phosphor above. The particle diameter of the phosphor averages 5 μm.

The following describes a specific size of each component of the double spiral fluorescent lamp 1.

A total length LO of the double spiral fluorescent lamp 1 is 137 mm, and an outer diameter L1 of the outer tube bulb 3 is 60 mm. Also, when observed in a plan view (when seen in a direction of the spiral axis A), a structural outer diameter Lb, a structural inner diameter, and a total length La of the glass tube 11 are 41.5 mm, 24.5 mm, and 88.8 mm, respectively. The outer diameter and the inner diameter of the spiral part 16 are 8.5 mm and 6.7 mm, respectively. A distance between adjacent spiral parts at the spiral part 16 is 1.2 mm, and a distance between the electrodes 14 and 15 is 700 mm.
2. Phosphor Coating Method for Glass Tube

The arc tube 2 is manufactured by performing processes of (A) forming a straight glass tube into a double spiral configuration, (B) coating the inner surface of the glass tube with phosphor to form a phosphor coating, and (C) fixing electrodes and enclosing a rare gas, mercury and the like.

The following describes the process (B) in detail.

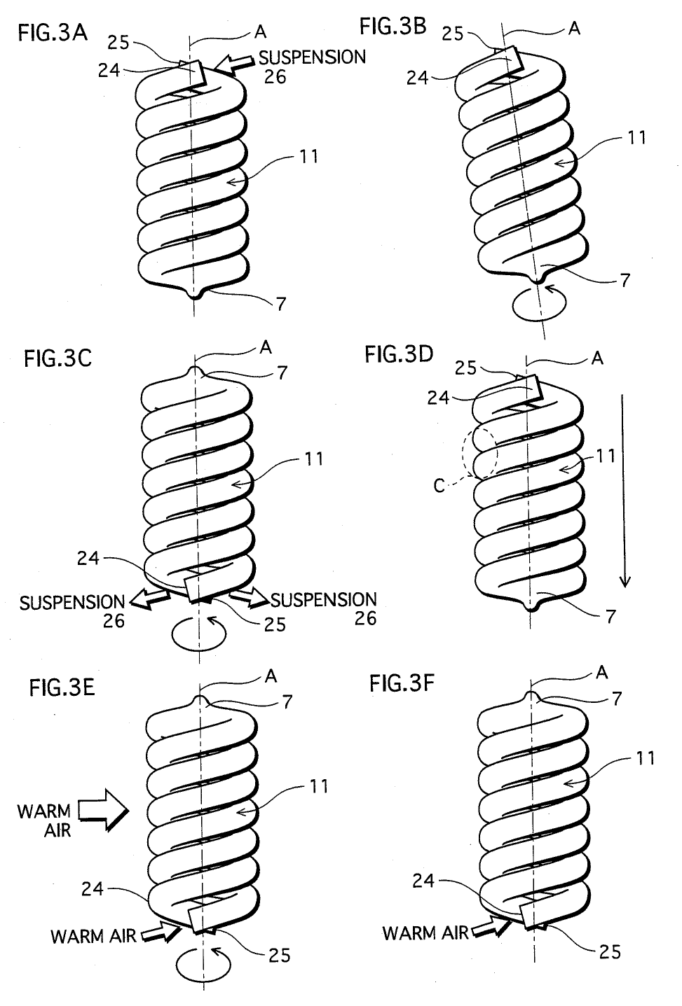

FIG. 3A to FIG. 3E show an overall flow of the phosphor coating method.

The phosphor coating method of the present embodiment includes (1) an injection process, (2) a draining process, (3) a reverse process, (4) a preliminary drying process, and (5) a main drying process.

(1) Injection Process

In the injection process, the glass tube 11 which has been formed into a double spiral configuration is positioned such that the openings 24 and 25 thereof are at the top and the turning part is at the bottom.

Then, a phosphor suspension 26 is injected through one opening 24 positioned at the top so as to fill the glass tube 11 [FIG. 3A].

After the injection, the glass tube 11 is lightly shaken to coat the entire inner surface of the glass tube 11 with the phosphor suspension 26 [FIG. 3B].

(2) Draining Process

Following the injection process, the draining process is performed. In this draining process, the glass tube 11 is turned upside down so that the turning part comes to the top and the openings 24 and 25 come to the bottom.

After that, the glass tube 11 is rotated around the spiral axis A to make excess phosphor suspension 26 drip (drain) from both openings 24 and 25 [FIG. 3C].

Note that rotating the glass tube 11 is to increase a draining speed.

In this draining process, the entire phosphor suspension moves downward due to gravity. As a result, the amount of coating decreases at the turning part 7 and increases as it gets closer to the openings 24 and 25 at the bottom, causing a variance in the amount of phosphor coating.

Also, in cross sections of the spiral part 16, the phosphor suspension moves along the inner surface of the glass tube 11 from the turning part 7 towards the openings 24 and 25, causing a variance in the amount of phosphor coating in each cross section as well.

(3) Reverse process (Reverse Flow Process)

Following the draining process, the glass tube 11 is turned upside down again so that the openings 24 and 25 come to the top, and the phosphor suspension 26 flows towards the turning part 7, which is in the direction away from the openings 24 and 25. The flowing time is approximately 5 seconds to 20 seconds.

In this reverse process, the flow of the phosphor suspension can be brought back to the turning part 7 side at the bottom, thereby reducing the variance throughout the glass tube 11 caused in the draining process.

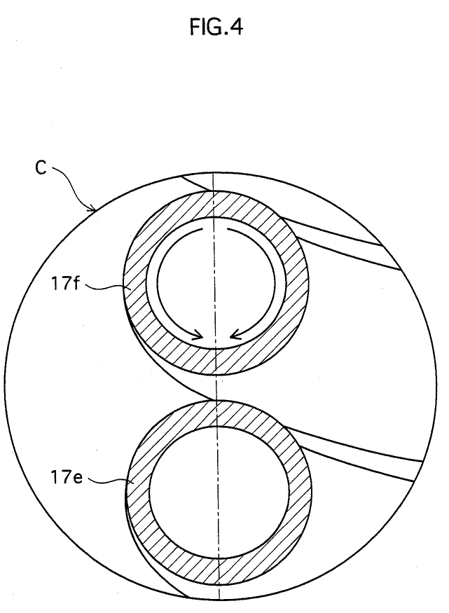

FIG. 4 is an enlarged front view of C part of the glass tube 11 in FIG. 3D. As shown in FIG. 4, in this reverse process, the flow of the phosphor suspension is also brought back to the turning part 7 side in a transverse cross section at a point along a discharge path of the spiral part 17f, thereby reducing the variance in each transverse cross section as well.

Also, since this process simply changes the position of the glass tube 11, it is suitable for a quantity-production.

It should be noted that during the present reverse process, it is preferable that the glass tube 11 be rotated in an opposite direction of the rotational direction in the draining process, particularly because the flow of the phosphor suspension 26 can be brought back efficiently.

(4) Preliminary Drying Process

Following the reverse process, the glass tube 11 is turned upside down again. Then, warm air is blown to the glass tube 11 externally while the glass tube 11 is rotated, and, at the same time, dry air at an ordinary temperature is blown thereinto through one opening 24, performing a preliminary drying of the phosphor suspension [FIG. 3E].

It should be noted that during this preliminary drying process, the phosphor suspension loses fluidity gradually, and loses the fluidity substantially completely in the middle of the process. In the first half of this preliminary drying process also, although not as rapid as the flow in the draining process, the phosphor suspension flows towards the openings 24 and 25.

(5) Main Drying Process

The main drying of the phosphor suspension 26 is performed by moving the glass tube 11 into a drying oven and blowing warm air thereinto through one opening 24 [FIG. 3F].
3. Comparative Test

The following describes results of a comparative test conducted to verify effects of the phosphor coating method pertaining to the present embodiment.

First, measurement positions of the amount of phosphor coating will be described.

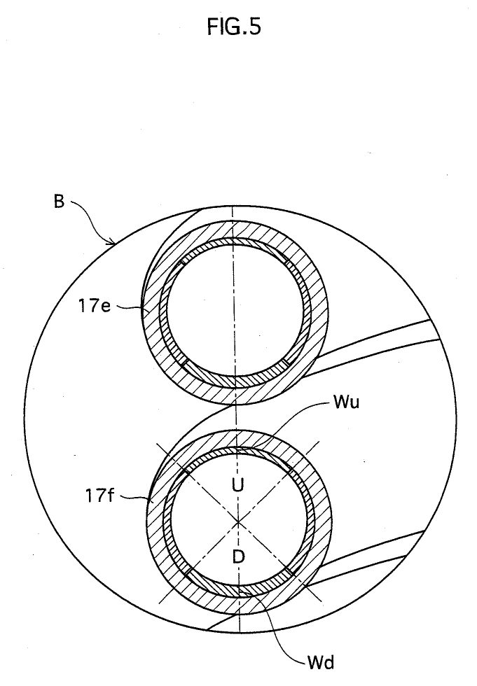

FIG. 5 is an enlarged front view of B part of the glass tube 11 in FIG. 2. The transverse cross section of the spiral part 17f was divided into 4 portions to conduct the measurement. Among the 4 portions, one portion on the turning part 7 side is referred to as an area U, one portion, on the openings 12 and 13 side, facing the area U is referred to as an area D. An average amount of phosphor coating in the area U is referred to as Wu, and an average amount of phosphor coating in the area D is referred to as Wd. Although not shown, these are the same for the other spiral parts 17a to 17e.

The present comparative test was conducted by comparing 60 samples of the glass tube 11 [coefficient of viscosity of the phosphor suspension 26 is 4.6*10⁻³ (Pa·s)], the present invention A, and 60 samples of glass tube (hereinafter, referred to as a “comparative A”), both sintered. Both samples have been actually quantity manufactured in a period of 20 days. The glass tubes 11 pertaining to the present invention A have been formed by performing the above processes (1) to (5), while the glass tubes pertaining to the comparative A have been formed by performing the above processes without (3) the reverse process, that is, performing (4) the preliminary drying process immediately after (2) the draining process.

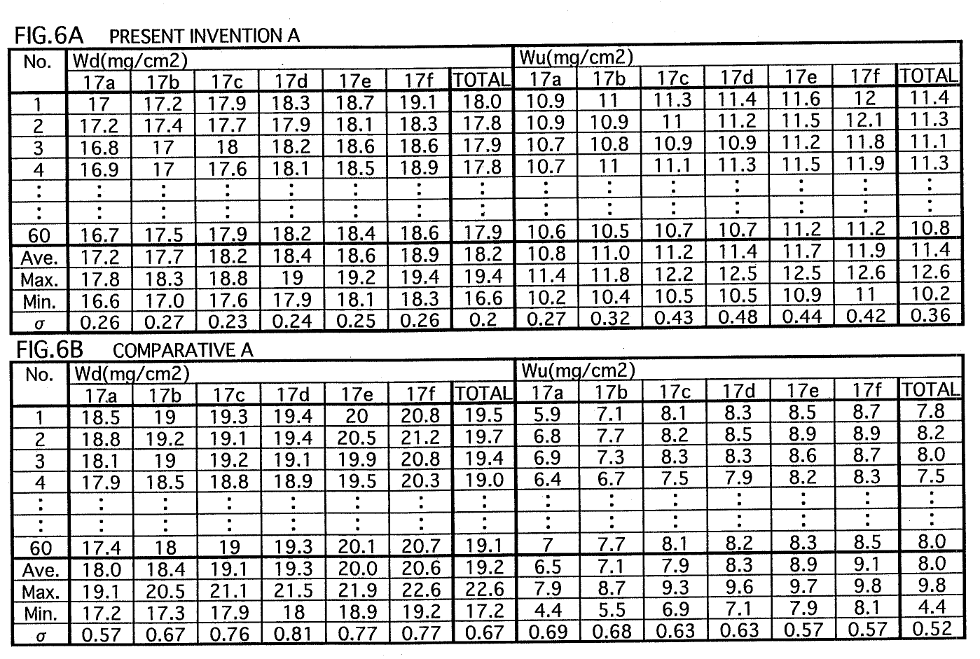

FIG. 6 shows measurement results of the amount of coating of the respective 60 samples. In order to avoid complication in the figure, only part, instead of all the 60 samples, of the results is shown.

“Ave.” indicates an average value of the total 60 samples, and “Max.” and “Min.” indicate the maximum value and the minimum value among the 60 samples, respectively.

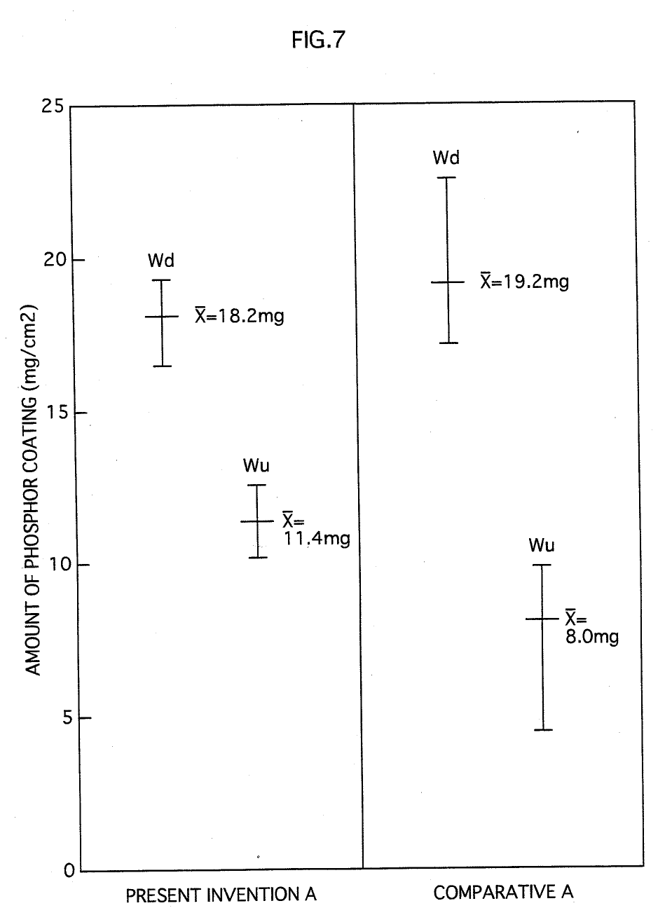

FIG. 7 is a diagram drawn based on the measurement results in FIG. 6.

As can be observed in FIGS. 6 and 7, in the glass tube 11 which is the present invention A, unevenness in the amount of coating throughout the lamp is suppressed.

In the glass tube 11, the present invention A, an amount of phosphor coating at Wd does not exceed twice that at Wu. Since there is a proportionate relationship between the amount of coating and the thickness of the phosphor coating, a thickness of the phosphor coating at Wd also does not exceed twice that at Wu.

Also, unevenness between Wu of the spiral part 17a (the spiral part 17a is, in the spiral part 16, a part closest to the turning part 7) and Wd of the spiral part 17f (the spiral part 17f is, in the spiral part 16, a part farthest to the turning part 7), showing a significant difference in the comparative A, is corrected.

In the comparative A, the average value of Wd of the spiral part 17f is 3.2 times that of Wu of the spiral part 17a (20.6/6.5=3.2). On the other hand, in the present invention A, the average value of Wd of the spiral part 17f is 1.75 times that of Wu of the spiral part 17a (18.9/10.8=1.75), showing decrease in disparity.

Also, as can be seen by comparing standard deviations s, the glass tubes 11 of the present invention A, show smaller values in the standard deviations than those of the glass tubes of the comparative A, which indicates a realization of less variance in the amount of coating from one lot to another.

It should be noted that in the glass tubes pertaining to the comparative A, the amount of coating tends to be thin, especially at the turning part 7 at the top. In an extreme case, the inner part was seen through the turning part 7.

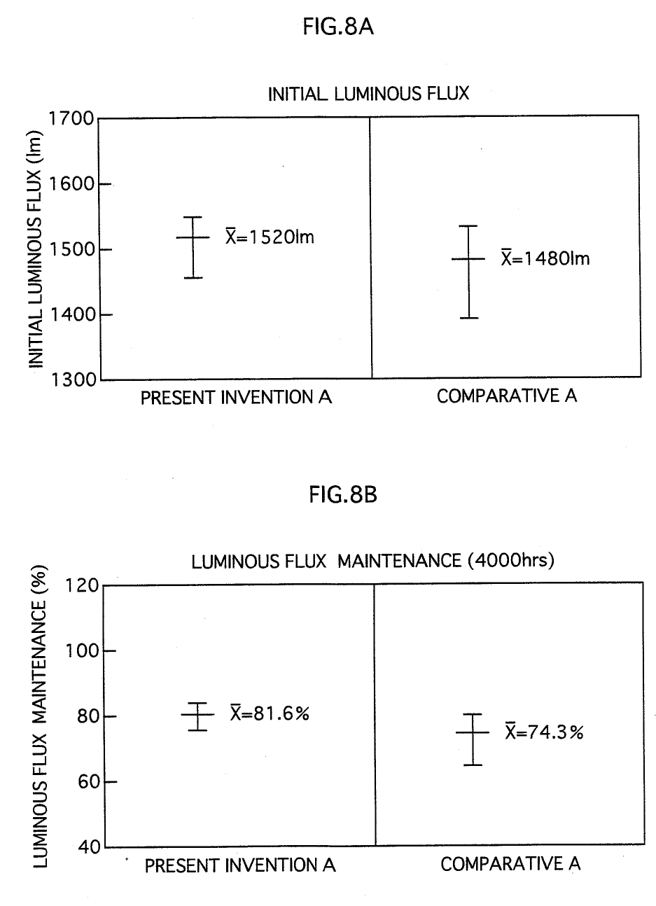

Next, double-spiral lamps were manufactured using the glass tubes in accordance with the present invention A and glass tubes in accordance with the comparative A, and an initial luminous flux and luminous flux maintenance were measured. FIGS. 8A and 8B show the results.

As are clear from FIGS. 8A and 8B, the lamp 1 using the glass tube 11, the present invention A, exhibited better initial luminous flux and luminous flux maintenance compared to using the comparative A.

### Second Embodiment

In this embodiment, the present invention is applied in a form of a flat spiral fluorescent lamp which includes a flat double-spiral arc tube. Since the present embodiment is basically the same as the first embodiment, an explanation will be mainly given on differences from the first embodiment, omitting explanations on common parts.
1. Structure of Flat Double-Spiral Fluorescent Lamp and Arc Tube

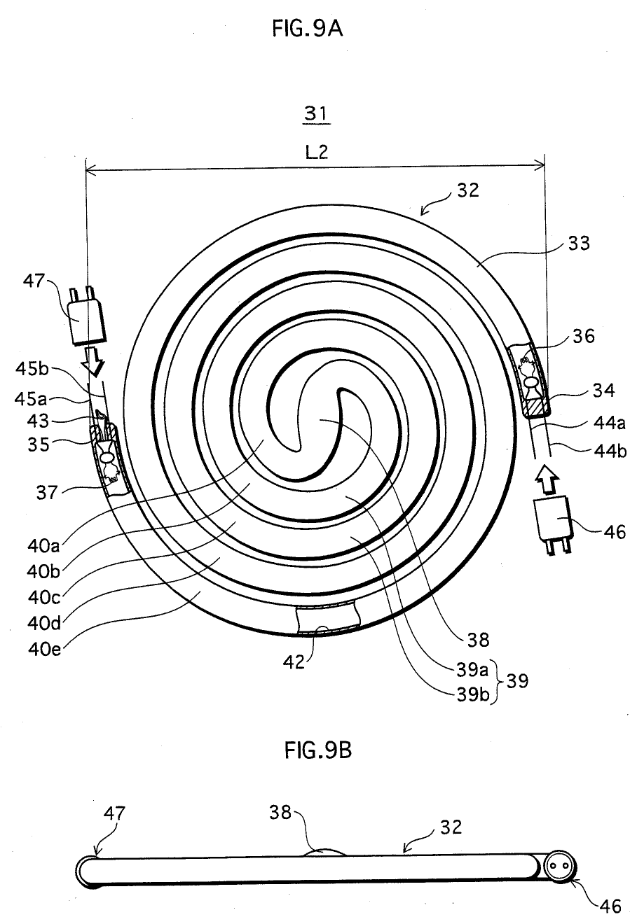

FIG. 9 shows a flat double-spiral fluorescent lamp 31 (hereinafter, referred to as “present invention B”), the second embodiment of the present invention. FIG. 9A is a partially cut-away exploded plan view, and FIG. 9B is a front view.

The flat double-spiral fluorescent lamp 31 is a 50 W input power type and includes an arc tube 32.

The arc tube 32 with a flat double-spiral configuration includes a glass tube 33 and electrodes 36 and 37 provided at both end parts 34 and 35, respectively, in the glass tube 33.

The glass tube 33 includes an S-shaped turning part 38 at the center, the end parts 34 and 35, and a winding part 39 which is wound into a flat spiral.

The winding part 39 includes a first winding part 39a and a second winding part 39b. The first winding part 39a is wound from the turning part 38 up to one end part 34. The second winding part 39b is wound from the turning part 38 up to the other end part 35.

As shown in FIG. 9B, the winding part 39 is substantially included in a single plane. It can be said that the winding part 39 is included in a plane of a tube axis of the glass tube 33.

A phosphor coating 42 is formed on the inner surface of the glass tube 33 in which mercury and a rare gas are enclosed (not shown).

It should be noted that an exhaust tube 43 is sealed to the end part 35.

The turning part 38 is where the coldest spot is formed during an illumination, and the shape is designed to provide the coldest temperature (55° C. to 65° C.) at which the luminous efficiency of the lamp is at highest.

The electrodes 36 and 37 include lead wires 44a and 44b/45a and 45b, respectively.

The lead wires 44a and 44b/45a and 45b extend to outside from inside the glass tube 33, and are electrically connected to bases 46 and 47.

It should be noted that the lamp 31 is attached to a lamp fitting (not shown) via the bases 46 and 47 and lit by a high frequency electronic ballast provided in the lamp fitting.

Here, reference numerals 40a to 40e are assigned to the winding part 39 from the turning part 38 in the center towards the end parts 34 and 35 in a sequential manner.
2. Outline of Arc Tube Manufacturing Process

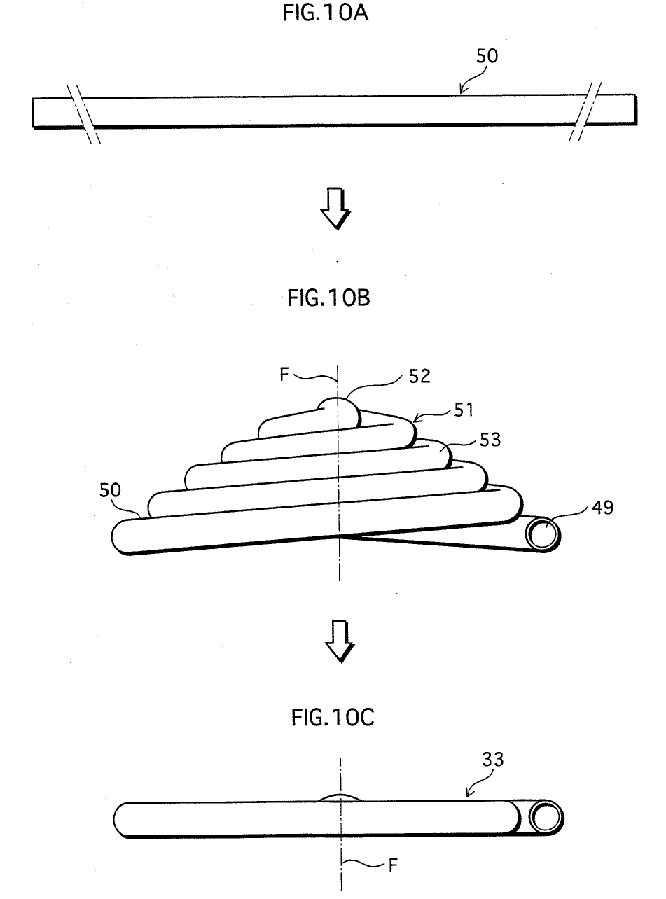

FIG. 10 is a schematic diagram showing an outline of an arc tube manufacturing process.

First, a straight glass tube 50 as shown in FIG. 10(a) is prepared and softened by heating. After that, by winding the glass tube 50 along a conical surface of a conical mandrel (not shown) and eliminating unnecessary portions at both ends by cutting, a glass tube 51 is formed (prepared).

The glass tube 51 is substantially a cone in outside shape when seen in a winding direction, and a protrusion 52 is formed at the top thereof.

Following the above process, a phosphor suspension is applied on the inner surface of the glass tube 51 which is substantially a cone in outside shape, and a sintering process is performed on the glass tube 51 to form a phosphor coating. Note that a subsequent heating step (a tube wall is heated to a temperature of 500° C. to 650° C.) of the glass tube 51 can be used as the sintering process.

Then, the glass tube 51 is heated again to be deformed into a flat shape in a direction of a central axis F such that the tube axis of the glass tube 51 is substantially aligned in a single plane.

After that, the arc tube 32 is manufactured by performing an electrode fixing process and an enclosing process. In the electrode fixing process, an electrode is sealed in each of the end parts of the glass tube 33 which has been deformed into a flat shape. And, in the enclosing process, mercury and a buffer gas are enclosed in the glass tube 33.

According to study by the inventors of the present invention, when the phosphor suspension is applied to the glass tube 33 which has been deformed into a flat shape, it is difficult to drain the injected phosphor suspension quickly, which leads to a problem of phosphor puddles formed locally within the glass tube 33.

Therefore, in the present embodiment, as shown in FIG. 10B, a phosphor suspension is applied to the double-spiral glass tube 51 which has not been flatly deformed yet.

Note that a spiral part 53 of the glass tube 51 corresponds to the winding part 39 of the flatly deformed glass tube 33.
3. Phosphor Coating Method for Glass Tube

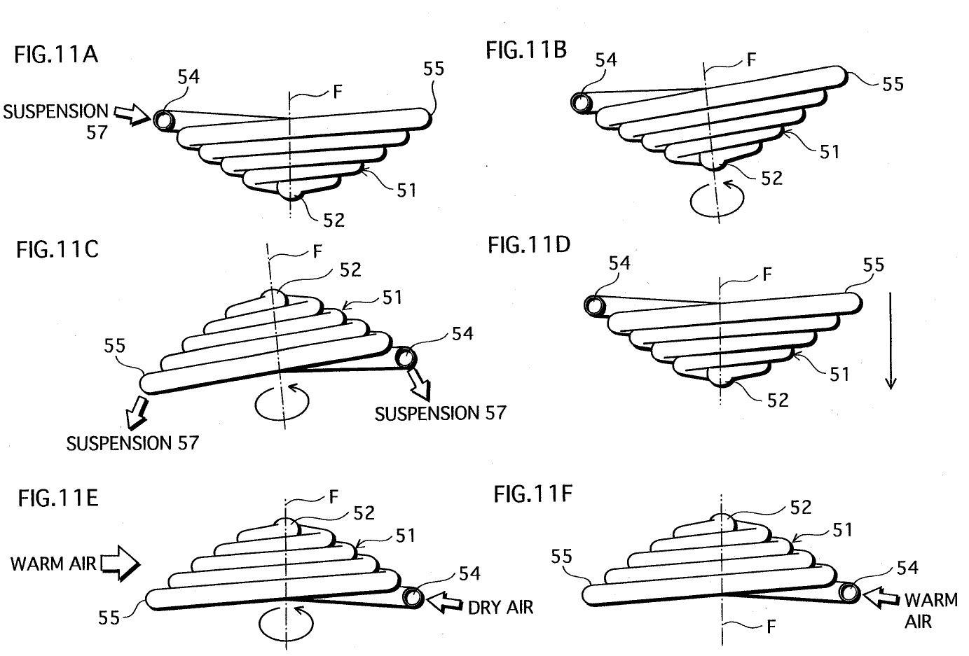

FIG. 11A to FIG. 11F show an overall flow of the phosphor coating method and correspond to FIG. 3 of the first embodiment.

The phosphor coating method includes (1) an injection process, (2) a draining process, (3) a reverse process, (4) preliminary drying process, and (5) a main drying process.

(1) Injection Process

In the injection process, the double-spiral glass tube 51 is positioned such that the openings 54 and 55 thereof are at the top and the turning part 52 is at the bottom.

Then, a phosphor suspension 57 is injected through one opening 54 positioned at the top so as to fill the glass tube 51 [FIG. 11A].

After the injection, the glass tube 51 is lightly shaken to coat the entire inner surface thereof with the phosphor suspension 57 [FIG. 11B].

(2) Draining Process

Following that, the glass tube 51 is turned upside down so that the turning part 52 comes to the top and the openings 54 and 54 come to the bottom, and the glass tube 51 is rotated around the axis F while being tilted to an approximately 8 degree angle with respect to the vertical direction to make excess phosphor suspension 57 in the tube drip (drain) from the openings 54 and 55 [FIG. 11C].

(3) Reverse Process

Subsequent to the draining process, the glass tube 51 is turned upside down again so that the openings 54 and 55 come to the top and the phosphor suspension 57 flows towards the turning part 52, which is in the opposite direction of the openings 54 and 55.

In this reverse process, the phosphor suspension 57 flows towards the turning part 52 at the bottom, thereby reducing the variance of the phosphor suspension 57 in the glass tube 51, which was caused by the draining process.

(4) Preliminary Drying Process

Following the reverse process, the glass tube 51 is turned upside down again. Then, warm air is blown to the glass tube 51 externally while the glass tube 11 is rotated, and, at the same time, dry air at a room temperature is blown therein through one opening 24, performing a preliminary drying of the phosphor suspension 57 [FIG. 11E].

The phosphor suspension loses fluidity gradually due to this preliminary drying process and loses the fluidity substantially completely in the middle of the process.

(3) Main Drying Process

The main drying of the phosphor suspension 57 is performed by moving the glass tube 51 into a drying oven and blowing warm air thereinto through one opening 54 [FIG. 11F].
4. Comparative Test

The following describes results of a comparative test conducted to verify effects of the phosphor coating method pertaining to the present embodiment.

In the present comparative test, as is the case with the first embodiment, the following samples were evaluated: (i) the glass tubes 33 pertaining to the present invention B, which have been deformed into a flat shape through the processes of the above-mentioned (1) to (5), and (ii) glass tubes (hereinafter, referred to as “comparative B”), on which the above (3) reverse process has not been performed.

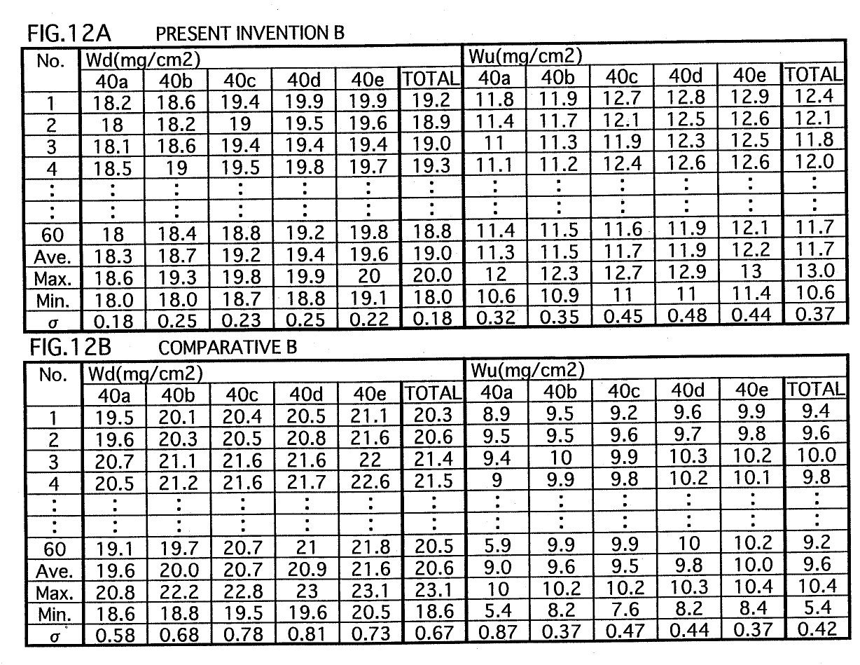

FIG. 12 to FIG. 14 correspond with FIG. 6 to FIG. 8, respectively.

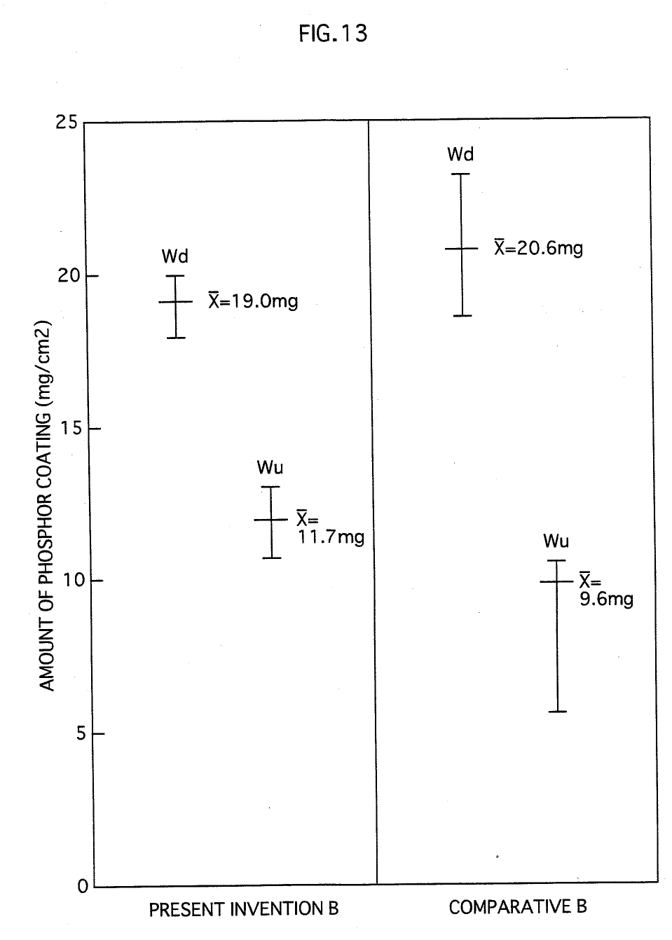

As is clear from FIGS. 12 and 13, a disparity between Wu and Wd in each transverse cross section at points along the discharge path of the winding parts 40a to 40e of the present invention B is considerably smaller compared to the comparative B.

Also, since variance in the amount of phosphor coating in the entire arc tube 32 is reduced compared to the comparative B, an amount of phosphor coating at a portion with the largest amount does not exceed twice that at a portion with the least amount. Especially, the unevenness between Wu (top side when being in a conical shape) of the winding part 40a (the winding part 41a is a part closest to the turning part 52) and Wd (opposite to the top side) of the winding part 40e (the winding part 40e is a part farthest from the turning part 52), which was significant in the comparative B, is corrected.

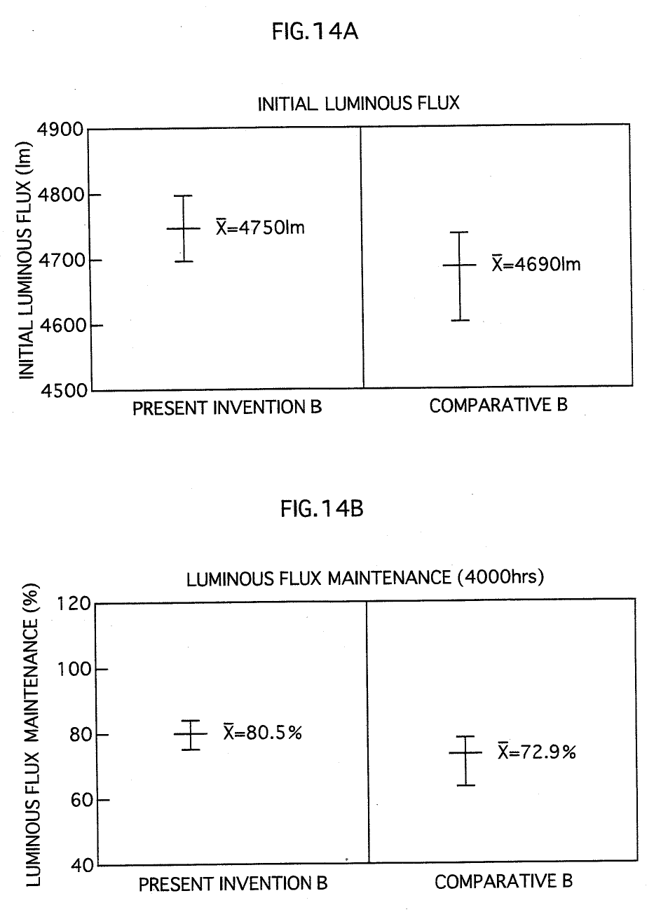

As is clear from FIG. 14, the lamp 31 using the arc tube 32, the present invention B, exhibited better initial luminous flux and luminous flux maintenance compared to using the comparative B.

### <Supplementary>

(1) The phosphor coating method of the glass tube, in accordance with the present invention, is not limited to the glass tubes with the above-mentioned configurations. For example, the above method can be applied to single spiral glass tubes which are wound in one direction around a spiral axis.
(2) While the glass tubes of the present invention have two openings, the present invention can be applied to glass tubes with one opening or with three or more openings.

### INDUSTRIAL APPLICABILITY

With the arc tubes in accordance with the present invention, a difference in thicknesses of phosphor coating therein can be kept within a predetermined range. Consequently, the above arc tubes can improve a luminous efficiency, and thus are useful.

1. An arc tube comprising a vertical double-spiral glass tube which includes a phosphor coating disposed on an inner surface thereof, wherein
the glass tube includes a spiral part made up of (i) a first spiral part wound around a spiral axis from a turning part to one end of the glass tube, and (ii) a second spiral part wound around the spiral axis from the turning part to another end of the glass tube, the turning part being positioned at a substantially central location in a tube longitudinal direction of the glass tube,
in a transverse cross section at a point along a discharge path of one of the first spiral part and second spiral part, a thickness of the phosphor coating at an area (wu) that is nearer, compared to an opposing area thereof, to the turning part and a thickness of the phosphor coating at the opposing area (wd) satisfy a relationship of ½wd/wu≦2.

2. An arc tube comprising a flat double-spiral glass tube in which a tube axis substantially lies in a single plane, the glass tube being in a flat shape deformed from an externally substantially cone-shaped glass tube, wherein
a phosphor coating is disposed on an inner surface of the glass tube,
the glass tube includes a winding part made up of (i) a first winding part wound into a flat spiral from a turning part to one end of the glass tube, and (ii) a second winding part wound into a flat spiral from the turning part to another end of the glass tube, the turning part being positioned at a substantially central location in a tube longitudinal direction of the glass tube, and
in a transverse cross section at a point along a discharge path of one of the first spiral part and second spiral part, a thickness of the phosphor coating at one (wd) of two areas and a thickness of the phosphor coating at the other area (wu) satisfy ½≦wd/wu≦2, the two areas being located in a direction orthogonal to the plane and facing each other across the plane.

3. An arc tube comprising a vertical single-spiral glass tube which includes a phosphor coating disposed on an inner surface thereof, wherein
the glass tube includes a spiral part wound around a spiral axis, and
in a transverse cross section at a point along a discharge path of one of the first spiral part and second spiral part, a thickness of the phosphor coating at one (wd) of two areas and a thickness of the phosphor coating at the other area (wu) satisfy ½≦wd/wu≦2, the two areas facing each other in a direction that is parallel to the spiral axis and passes through a center of the cross section.

4. A phosphor coating method for coating an inner surface of a spiral-shaped glass tube including a winding spiral part and two openings, each disposed at different one of two ends of the glass tube, the phosphor coating method comprising:
(a) an injection step of injecting a phosphor suspension into the glass tube;
(b) a draining step of draining the phosphor suspension from at least one of the openings after the injection step while the glass tube is retained such that the at least one of the openings is positioned, within the glass tube, on a lower side in a vertical direction;
(c) a reverse step of flowing a remainder of the phosphor suspension in the glass tube in a direction opposite to the at least one of the openings after the draining step while the glass tube is retained such that the at least one of the openings is positioned, within the glass tube, on an upper side in the vertical direction; and
(d) a drying step of drying the remainder of the phosphor suspension in the glass tube after the reverse step while the glass tube is retained such that the at least one of the openings is positioned on the lower side.

5. The phosphor coating method of claim 4, wherein
the glass tube is in a double spiral shape such that (i) when one of the openings is positioned on the upper side, the other opening is also positioned on the upper side, and (ii) when one of the openings is positioned on the lower side, the other opening is also positioned on the lower side.

6. The phosphor coating method of claim 4, wherein
the glass tube is in a single spiral such that (i) when one of the openings is positioned on the upper side, the other opening is positioned on the lower side, and (ii) when one of the openings is positioned on the lower side, the other opening is positioned on the upper side, wherein
in the draining step, the phosphor suspension is drained from one of the openings while the glass tube is retained such that the one of the openings is positioned on the lower side and the other opening is positioned on the upper side,
in the reverse step, a remainder of the phosphor suspension in the glass tube is flowed in the direction opposite to the one of the openings while the glass tube is again retained such that the one of the openings is positioned on the upper side and the other opening is positioned on the lower side, and
in the drying step, the remainder of the phosphor suspension in the glass tube is dried while the glass tube is again retained such that the one of the openings is positioned on the lower side and the other opening is positioned on the upper side.
